(19) United States
(12) Patent Application Publication
(10) Pub. No.: US 2016/0332678 A1
(43) Pub. Date: Nov. 17, 2016

(54) CROP HAULING BED LOADING PANEL

(71) Applicant: Charles Wayne Leonardson, Blackfoot, ID (US)

(72) Inventor: Charles Wayne Leonardson, Blackfoot, ID (US)

(21) Appl. No.: 14/709,507

(22) Filed: May 12, 2015

(51) Int. Cl. B62D 33/027; B65G 67/04; E05F 15/57

(52) U.S. Cl. CPC B62D 33/0276; E05F 15/57; B65G 67/04; E05Y 2900/518

(57) ABSTRACT

A vehicle may be provided with a crop hauling bed. The bed may include a frame configured to be mounted to the chassis of a vehicle or trailer (the frame supporting body panels which provide a volume suitable for holding harvested crops), a door opening along a side edge of the frame, a door coupled to the frame such that the door is selectively and slidably openable and closable to cover the door opening, and at least one actuator configured to slidably move the door between an open position and a closed position. The bed may also include a slide mechanism slidably coupling the door to the frame.

### FIELD

This application relates generally to farming equipment. More particularly, this application relates to a truck or trailer bed having a side loading panel for loading and transporting harvested fruits and vegetables from the field.

### BACKGROUND

Modern harvesting equipment is essential is efficient farming. Specialized harvesting equipment allows for minimum labor in harvesting large amounts of crops. With potatoes, onions, beets, and other root vegetables, harvesters dig into the ground and separate the vegetables from the greens and the dirt through a series of belts. The harvesters then load the harvested vegetables into vegetable trucks, which are filled as they drive along next to the harvester. Some vegetable trucks are trailers for semi-tractors and others are special beds on heavy trucks.

Fruit and vegetable hauling trucks and trailers usually have a side that swings out on a hinge and drops down to allow the harvester to position a loading boom close over the truck and close enough to the bottom of the payload floor to limit damage to the harvested crop as they are loaded into the bed. As the as the bed is filled, the loading boom rises as the level of the vegetables in the truck rises and the drop side is eventually raised to allow the entire bed to be filled.

Current drop sides are often raised and lowered by swinging a side panel down around a hinge at the bottom of the panel using an automatic actuator. The drop sides can sometimes hit the loading boom when being raised, which can damage the drop panel or the automatic actuator and mechanisms for opening and closing the panel, or the loading boom and its components. Such side panels also require a relatively long boom to allow enough room for the door to swing shut, and a careful distance management between the harvester and the hauling bed. Additionally, the side panel sometimes damages some of the vegetables by pinching them in the hinged section. The hinged drop panels also require a long loading boom to allow the truck to travel to the side of the harvester without the panel striking the harvester or the boom when being lowered and raised.

### SUMMARY

A vehicle may be provided with a crop hauling bed. The bed may include a frame configured to be mounted to the chassis of a vehicle or trailer (the frame supporting body panels which provide a volume suitable for holding harvested crops), a door opening along a side edge of the frame, a door coupled to the frame such that the door is selectively and slidably openable and closable to cover the door opening, and at least one actuator configured to slidably move the door between an open position and a closed position. The bed may also include a slide mechanism slidably coupling the door to the frame.

In some embodiments, the slide mechanism may include pins and slots. The pins may extend from the door and the slots may be formed in the frame or vice-versa. In some embodiments, the at least one actuator may be a linear actuator such as a hydraulic cylinder, screw jack, pneumatic cylinder, chain and pulley with an electric motor, etc. The at least one actuator may be powered by a vehicle coupled to the bed, and may be controlled from the cab of the vehicle. The door may also include a layer configured to reduce damage to harvested crops.

Loading crops in the crop hauling bed may be accomplished by providing a harvester to harvest a crop and deliver it to a vehicle with a crop hauling bed having a loading door. The loading door may be slidably lowered from a closed position to an open position on the crop hauling bed using actuators. The harvested crops may then be loaded into to crop hauling bed, and the loading door slidably raised on the crop hauling bed to a closed position as the crop hauling bed fills with harvested crops.

These and other aspects of the present invention will become more fully apparent from the following description and appended claims.

### BRIEF DESCRIPTION OF THE DRAWINGS

The following description can be better understood in light of Figures, in which:

FIG. 1a is a perspective view of an exemplary embodiment of a loading door on crop hauling bed in an open position;

FIG. 1b is a perspective view of an exemplary embodiment of a loading door on crop hauling bed in a closed position;

FIGS. 2a-2b are detailed views of a slide mechanism an exemplary embodiment of a loading door on crop hauling bed;

FIGS. 3a-3b illustrate a door panel accommodation of an exemplary embodiment of a loading door on crop hauling bed in an open and closed position; and

FIGS. 4a-4b illustrate an actuator mechanism of an exemplary embodiment of a loading door on crop hauling bed in an open and closed position.

Together with the following description, the Figures demonstrate and explain the principles of loading doors on hauling beds and associated methods. In the Figures, the size and relative placement of components and regions of illustrated devices may be exaggerated or modified for clarity. The same reference numerals in different drawings represent the same element, and thus their descriptions may not be repeated. Some drawings may omit certain components not necessary for describing the illustrated embodiments, but which would be known to those of ordinary skill in the art to be present in hauling beds.

### DETAILED DESCRIPTION

As in the illustrated embodiments, aspects and features of exemplary loading doors on crop hauling beds and associated methods of making and using such doors are disclosed and described below. The following description supplies specific details in order to provide a thorough understanding. Nevertheless, the skilled artisan would understand that the apparatus and associated methods of using the apparatus can be implemented and used without employing these specific details. Indeed, the devices and associated methods can be placed into practice by modifying the illustrated devices and associated methods and can be used in conjunction with any other apparatus and techniques conventionally used in the industry. For example, while this description focuses on loading doors on crop hauling bed attached to a truck chassis, embodiments employing the principles described herein may be used on or with trailers, or other load-hauling machinery, mechanisms, vehicles, devices, etc. without departing from the scope of the devices described herein.

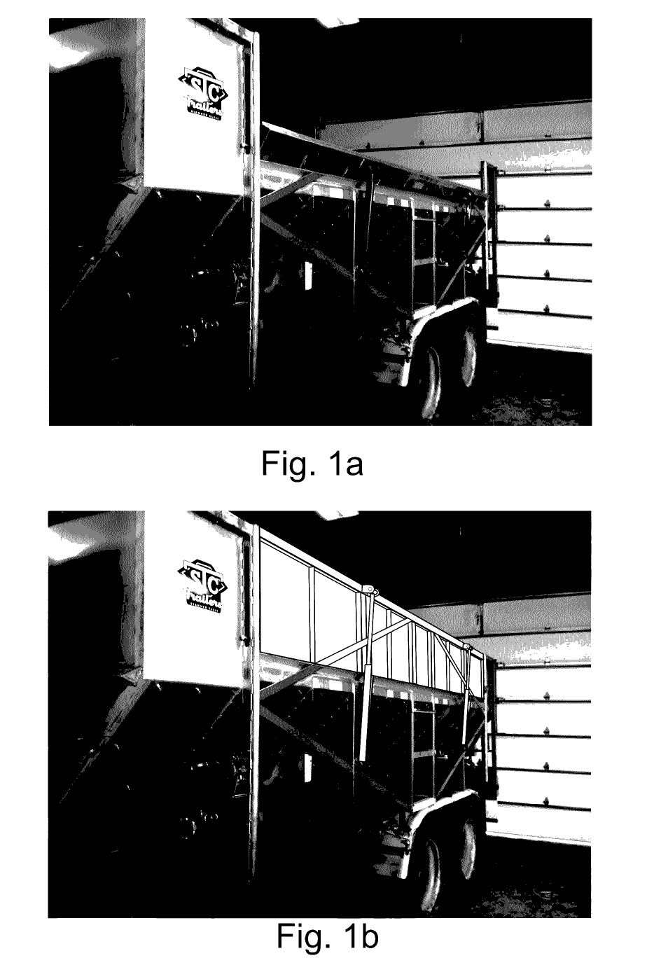

FIGS. 1a-4b illustrate various features of a produce hauling bed 20 on a truck chassis 10. The hauling bed 20 may include a loading door 100. Loading door 100 and hauling bed 20 may include slide mechanism 130 to slidably attach loading door 100 to truck chassis 10, and actuators 160 to move loading door 100 between a closed (FIG. 1a) and an open (FIG. 1b) position.

Loading door 100 may open and close by sliding a top portion 112 vertically until loading door 100 is in a closed position where a bottom portion 114 engages with a lower lip 24 of a door frame in hauling bed 20, thereby providing additional volume within hauling bed 20. Loading door 100 may be gradually raised as hauling bed 20 is filled to provide a continuous short drop for harvested produce, reducing the amount of loss from bruising. Additionally, the generally vertical closing motion of loading door 100 may provide less risk of damage to loading door 100 and to a harvester depositing into hauling bed 20.

Generally, traditional hauling beds usually have a loading door that swings out and drops down around a hinge to allow the harvester to position a loading boom close over the truck and close enough to the bottom of the payload floor to limit damage to the harvested crop as they are loaded into the bed. Current drop sides are often raised and lowered by swinging a side panel down around a hinge at the bottom of the panel using an automatic actuator. The drop sides can sometimes hit the loading boom when being raised, which can damage the drop panel or the automatic actuator and mechanisms for opening and closing the panel, or the loading boom and its components. Such side panels also require a relatively long boom to allow enough room for the door to swing shut, and a careful distance management between the harvester and the hauling bed. Additionally, the side panel sometimes damages some of the harvested crops by pinching them in the hinged section. The hinged drop panels also require a long loading boom to allow the truck to travel to the side of the harvester without the panel striking the harvester or the boom when being lowered and raised.

In contrast to traditional hauling beds, the present embodiments of exemplary loading doors 100, including those illustrated in FIGS. 1a-4b, slide up into a closed position (FIGS. 1b, 2b, 3b, 4b) using actuators 160 thereby eliminating the room required for the traditional outwardly swinging loading doors, and minimizing potential damage to harvester booms and the loading door 100. Additionally, the sliding action of loading doors 100 may reduce produce damaged by traditionally closing hinged doors that would crush loaded produce in the hinge intersection.

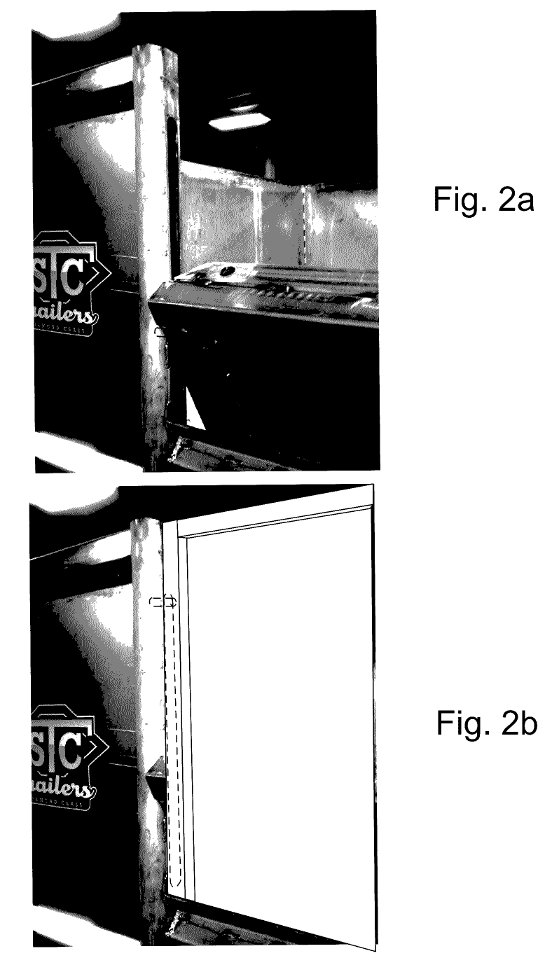

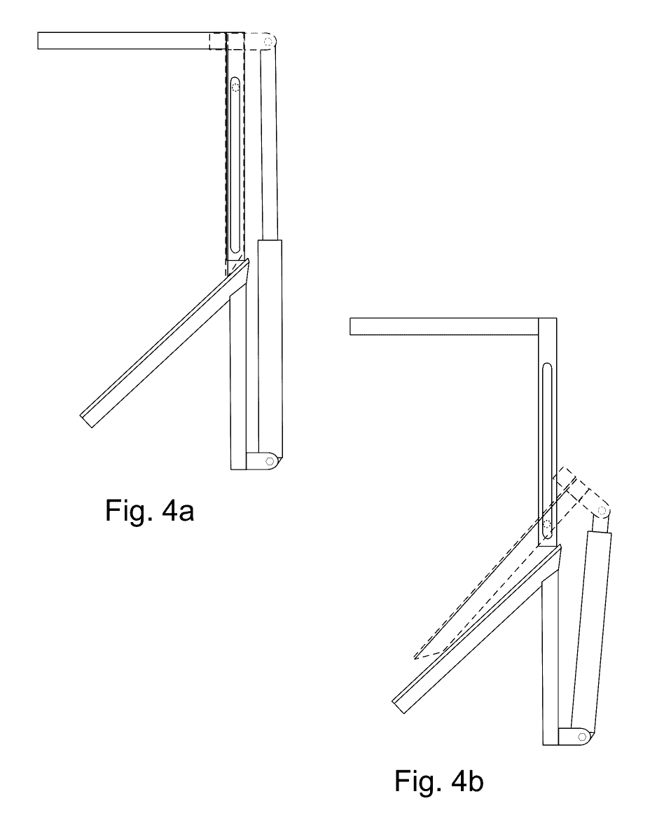

As best shown in FIGS. 2a-2b, 4a-4b, slide mechanisms 130, 140 may include pins 134, 144, slidably engaged in slots 132, 142. As shown in FIGS. 2a-2b, slot 132 is formed in frame member 26, which forms an edge of an opening for loading door 100. Pin 134 may be located on an edge of loading panel 110 close to top 112 of loading door 100 such that when pin 134 slides in slot 132, top 112 generally moves vertically to open/shut loading door 100. As top 112 moves up, bottom 114 follows the contour of the bed 20 until bottom 114 engages with frame edge 24, indicating a fully closed loading door 100, as shown in FIGS. 1b, 2b, 3b, 4b. When closing loading door 100 with harvested produce in the bed bottom 114 slides out from under the loaded produce with low risk of damage to the loaded produce.

Actuators 160 may be used to push loading door 100 open. Actuators 160 may be attached to bracket 111 on upper portion 110 of loading door 100 and to chassis 10 or bed 20, such that when actuator 160 is activated, loading door 100 moves between the open and closed positions, or vice versa. Actuators 160 may be hydraulic cylinders controlled with a hydraulic system of chassis 10, or may be any actuator capable of moving loading door between closed and open positions. In some embodiments, actuators may of any suitable type and controlled using vehicle hydraulic, pneumatic, or electrical systems.

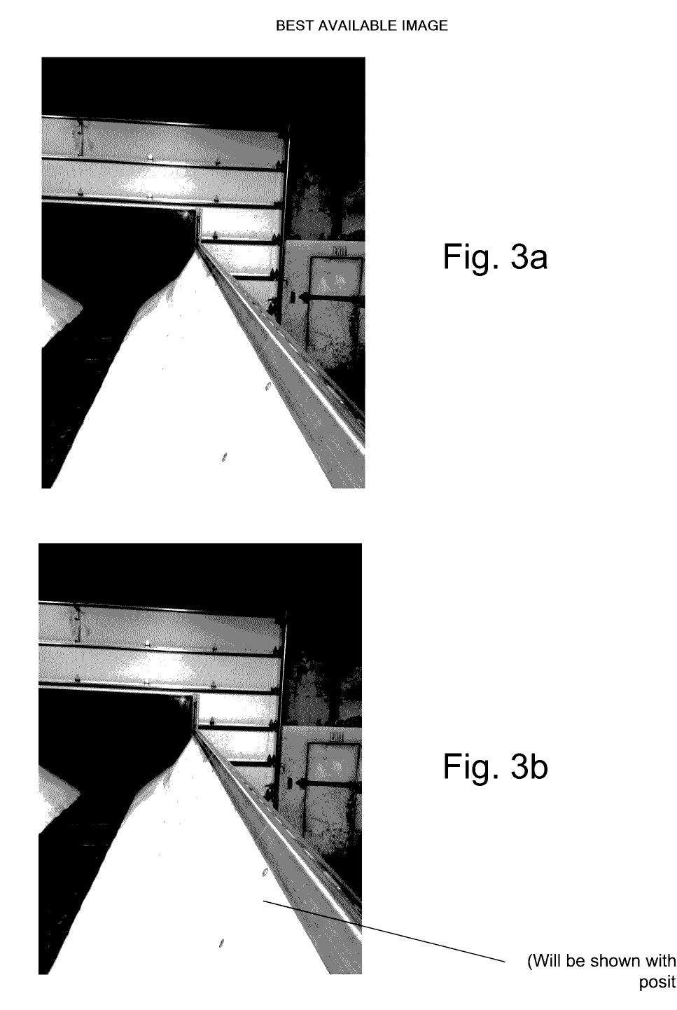

The various components of loading door 100 and bed 20 may be formed of steel, aluminum, or any suitable material or alloy used in the construction of such items. In some embodiments, the inside of hauling bed 20, including an inside surface of loading door 100, may be lined with plastic layer, such as HDPE, PTFE or may be treated with a surface treatment to facilitate protection or movement of loaded produce in hauling bed 20, including offload through door 22 as shown in FIGS. 3a-3b. In some embodiments, pins 134, 144 may include bearings or bushings, or other similar device, to reduce wear between slot 132, 142 and pins 132, 142.

In some embodiments, slot 132 may be through two sides a hollow tube frame member 26, or may be through only one side such that the pin movement is hidden within the frame member, with a similar arrangement for slot 142 and its corresponding frame member. In other embodiments, frame member 26 may be a solid piece with a channel or a slot to cooperate with pin 134. Similarly, the slots may be provided in a portion of door 100 and the pins may be provided extending from frame member 26. In some embodiments, doors consistent with this description may be retrofitted onto existing beds by replacing a section of the bed walls or by replacing the traditionally outward swinging door.

Similarly, in some embodiments, the actuators 160 may be a single actuator located near the center of the door, or the actuators may be positioned at the very edges of door 100 close to the slide mechanisms 130, 140.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

What is claimed is:

1. A crop hauling bed, the bed comprising:
a frame configured to be mounted to the chassis of a vehicle or trailer, the frame supporting body panels which provide a volume suitable for holding harvested crops;
a door opening along a side edge of the frame;
a door coupled to the frame such that the door is selectively and slidably openable and closable to cover the door opening; and
at least one actuator configured to slidably move the door between an open position and a closed position.

2. The bed of claim 1, further comprising at least one slide mechanism slidably coupling the door to the frame.

3. The bed of claim 2, wherein the slide mechanism includes pins and slots.

4. The bed of claim 3, wherein pins extend from the door and the slots are formed in the frame.

5. The bed of claim 1, wherein the at least one actuator is a linear actuator.

6. The bed of claim 5, wherein the at least one actuator is a hydraulic cylinder.

7. The bed of claim 1, wherein the at least one actuator is powered by a vehicle coupled to the bed.

8. The bed of claim 7, wherein the at least one actuator is controlled from the cab of the vehicle.

9. The bed of claim 1, wherein the door includes a layer configured to reduce damage to harvested crops.

10. A method of loading crops in a crop hauling bed, the method comprising the steps of:
providing a harvester;
providing a vehicle with a crop hauling bed having a loading door;
slidably lowering the loading door from a closed position to an open position on the crop hauling bed using actuators;
loading the crop hauling bed from the harvester with harvested crops; and
slidably raising the loading door on the crop hauling bed to a closed position as the crop hauling bed fills with harvested crops.

11. The method of claim 10, wherein the actuator are hydraulic cylinders.

12. The method of claim 10, wherein the actuators are powered by the vehicle.

13. The method of claim 12, wherein the actuators are controlled from the cab of the vehicle.

14. The method of claim 10, wherein the door includes a layer configured to reduce damage to harvested crops as they are loaded and as the door is raised.
